(19) United States
(12) Patent Application Publication
(10) Pub. No.: US 2020/0166014 A1
(43) Pub. Date: May 28, 2020

(54) SOLID PUMPED HYDRO ENERGY STORAGE USING SLURRY

(71) Applicant: Saugato Mukerji, New South Wales (AU)

(72) Inventor: Saugato Mukerji, New South Wales (AU)

(21) Appl. No.: 16/624,892

(22) PCT Filed: Aug. 7, 2018
(86) PCT No.: PCT/AU2018/095001

§ 371 Date: Dec. 19, 2019

(30) Foreign Application Priority Data
Aug. 13, 2017 (AU) 2017213583

(51) Int. Cl. F03B 13/06; F03G 3/04; H02J 3/28

(52) U.S. Cl. CPC F03B 13/06; F03B 17/005; H02J 3/28; F03G 3/04

(57) ABSTRACT

Low cost Pumped Hydro Energy Storage (PHES) sites have already been exploited; new PHES sites now cost $2 million per MW. A very large number of sites exist, not only on the coast but all over the land mass of all continents, that have an altitude difference of 100 m between two levels, where 1 to 5 million tonnes of solid can solid can safely be stored at both high and low levels. Thus solids like sand, crushed rock and soil can be used to provide virtually unlimited gravitational energy storage. Pumping slurry of solid/water to an upper level creates energy storage. When required, solid in slurry form flows down to the lower level, through a turbine. The turbine runs a generator releasing electrical energy. A relatively small amount water is recycled indefinitely create more slurry and transfer solid up/down as needed making solid pumped hydro feasible even in deserts.

### BACKGROUND

Pumped Hydro is a technique for storing excess electrical energy by pumping water up into a higher level reservoir from a lower reservoir in the form of gravitational potential energy. This potential energy is released at a later time when electrical energy demand exceeds supply. The water is allowed to flow down from the higher to the lower reservoir through a turbine connected to a generator converting the kinetic energy in the water flow to electrical energy which is fed to the transmission grid.

The number of convenient locations where two such reservoirs are available at higher and lower levels is a limitation. A further limitation is the smaller of the capacities of the higher and lower reservoirs, determines the capacity of the stored energy project. An additional limitation is the need to replace the water lost due to evaporation in the two reservoirs on a daily basis. This can be a serious challenge where the site is located in an arid region with higher temperatures and low humidity.

The cost of a pumped hydro project if also affected by the amount of earthwork and construction that has to be done to create two water tight reservoirs at different levels. A good site allows a small length of dam to create a large reservoir.

If a solid could be stored two locations at different altitudes and allowed to move from a higher to a lower location, a similar function like pumped hydro could be created. The additional benefit is that a much less rigorous containing earthwork or construction is needed to store the solids at the two locations.

The challenge of solid pumped storage is to transport the solid to the higher location and then to efficiently recover the energy when the solid is transferred down from the higher to the lower location. This entire operation needs to happen in an economically viable manner, when compared with other forms of large scale energy storage like conventional pumped hydro or battery farms.

The transport can be done using conveyors to transfer the solid between the two locations. The electrical motors which run the conveyor when moving solid material up to the higher location, can reverse roles and act as generators when solid material is moved down. While the conveyor approach is feasible, the cost starts to become very high when 720,000 tonnes/hr of solid needs to travel downhill though 100 m to deliver 200 MW capacity.

Gravitational potential energy contained in 1000 kg raised through 100 metres is 1 mega joule(MJ). 1 MJ/sec is 1 MW of power so 3600 MJ/hour is 1 MWH. This means 3600 tonnes of solid need to be raised through 100 m to develop 1 MWh of gravitational potential energy. If the round trip efficiency is 60% then 6000 tonnes(3600/0.6=6000) will need to be raised through 100 m to deliver 1 MWh of stored energy back to the grid. This will halve to 3000 t if the elevation is doubled to 200 m and halve again to 1500 t if the elevation is doubled again to 400 m. Assuming an elevation of 200 m and energy storage of 400 MWh and a sand density of 2.3 t/m³this translates to a stored sand volume of 520,000 m³ (3000×400/2.3=521,739 m³). The size of the heap using sand will be a 300 m square and 6 m high. If the slurry is 30% water this translates to a water flow 170000 m³ (170 ML) of water per hour. The water is recycled within 1 hour, so total water storage of 300 ML may be able to sustain a 200 MW 4 hour pumped solid storage facility allowing for a 50% safety margin.

Solid energy storage can also be done using electric motor driven railway wagons or trucks to transfer solid material up and electrical regenerative braking used to recover the energy when transporting solid down. There is an active project called ARES in Neveda US which does this. Solid Pumped Hydro achieves a similar energy storage outcome at a lower cost and uses less land area per MWH.

Solid Pumped Hydro Innovation Statement

The main idea underpinning, pumped storage based energy storage is the following. Gravitational energy storage is created over many hours by using variable amounts of excess electrical energy as it becomes available. The energy is released at a much higher steady rate over a shorter time span. i.e. Energy is stored at a rate of 10-40 MW over 8 to 24 hours then the energy is released over 2 to 5 hours at rates of 100 MW to 250 MW. It is advantageous if the rated energy capacity can be dispatched within 5 min or less of starting up as delivered by Solid Pumped Hydro.

The innovation in this patent is to create fluid slurry made from a mixture of water and solid material like sand or crushed iron ore. The slurry can then be pumped up using large capacity pumps. 8000 tonnes/hr slurry pumps called “Super Pump” are used in series to drive a 3.5 km pipeline daily, and are in service for Oil Sands Hydrotransport at SynCrude Canada. In this case the pump(s) will be used to move the slurry for a shorter distance but will be used to pump the slurry, to a higher elevation of 100-200 m.

A number of parallel Super pump pipelines can be used to increase the upward pumping rate. The water continuously separates easily from the solid in slurry at the higher location. The separated water is allowed to flow back downhill driving a water turbine at the lower location to recover part of the energy, used by the slurry pump operation. A small reservoir at the lower level is the interim location for the recovered water. The recovered water held at lower location, is recycled to make more slurry for the upward pumping operation. The elegance of the slurry operation is that a relatively small amount of water can be cycled to indefinitely maintain a continuous slurry pumping operation.

In the energy release phase of the operation, water is pumped up to the higher location by reversing the mode of the water turbine-generator at the lower location to operate like a pump. The sand at the upper location is fed into a slurry making hoppers using a series of conveyors. Water is pumped into the slurry hopper to make the slurry of the desired proportion (i.e 30% water 70% sand)

The slurry flows down the tubular equivalent of the penstock to the turbine where the kinetic energy of the slurry is converted to rotational energy and extracted as electrical energy by the generator and fed into the grid. The slurry then discharges into a large holding area and gradually settles and the water fraction eventually separates and is drained to the interim reservoir at the lower location.

The energy storage capacity is determined by the land available at the lower and higher levels. If more land is available at the higher and lower level i.e. a plateau or an escarpment landform then it may support more extended solid pumped storage despatch capability using the same infrastructure. Expanding the upper and lower storage area from 300 m×300 m×6 m to 1000 m×1000 m×6 m for a 200 m elevation will expand the dispatchable 200 MW storage from 4 hours to 44 hours at relatively modest increase in cost excluding the land area cost. Ability to cheaply expand the capacity as offered by Stored Pumped Hydro is not available with other energy storage options like battery farms and compressed air.

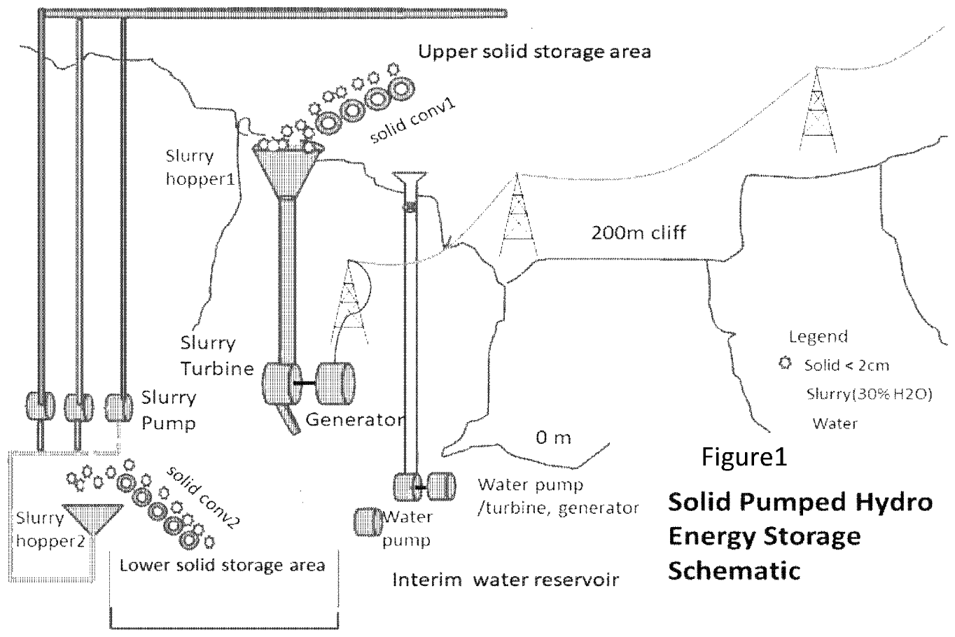

1. I claim the use of pumping to a higher elevation shown as upper solid storage area in FIG. 1, of a slurry made with available solid sand, gravel, soil, crushed rock, mineral ore, or any processed solid of particle/lump size less than 2 cm, to store gravitational potential energy by retaining the solid at the higher elevation in a self-supporting heap.

2. (canceled)

3. (canceled)

4. (canceled)

5. (canceled)

6. (canceled)

7. From the self-supporting heap as defined in claim 1, I claim the recovery of the energy from the water flowing back to the lower elevation via pipes due to gravity via a separate water energy recovery turbine. The turbine output water is collected in the interim water reservoir shown in FIG. 1.

8. (canceled)
